(19) United States
(12) Patent Application Publication
(10) Pub. No.: US 2011/0064901 A1
(43) Pub. Date: Mar. 17, 2011

(54) SUPER INSULATING FAN-FOLD RADIANT BARRIER

(76) Inventors: Farron Blackburn, Keller, TX (US); Eric Scott Thomes, Keller, TX (US)

(21) Appl. No.: 12/560,413

(22) Filed: Sep. 15, 2009

(51) Int. Cl. B32B 3/10; B32B 15/00; B65D 65/28

(52) U.S. Cl. 428/43; 428/457; 428/137; 428/134

(57) ABSTRACT

An insulating panel for inhibiting the passage of radiant and conductive heat into or out of an enclosed structure through the attic, foundation, windows, doors, and skylights where the panel is laminated. The core of the panel is of extruded polystyrene or expanded polystyrene having a thickness of between 1/16 of an inch to 1½ inches. The core of the panel is coated with a fire retarding material which can be an adhesive and which is used to attach a metalized film such as aluminum to each side of the core. Apertures are located in the core and metalized films to allow air to pass through the panel, and the panel is scored to allow it to be folded.

### BACKGROUND OF THE INVENTION

1. Field of the Invention

This invention relates to a insulating fan-fold radiant barrier apparatus, and, more particularly, to an insulation material and reflective metalized film or radiant barrier combined together for reflecting and inhibiting the transfer of heat.

2. Description of the Prior Art

In the daytime, and specifically in the summer heat from sunlight will raise the temperature of a roof which will be conducted through the shingles on the roof and pass thru and heat the floor of the attic. To inhibit the transfer of heat from the attic to the living space below, the floor of the attic is normally insulated. Insulation properly installed on the floor of the attic will significantly reduce the transfer of heat through the attic floor to the living area below.

Presently there are different types of insulation which are used in the attic to inhibit the transfer of heat to the living area below in the summer. One type of material is loose fill blown insulation, which is typically ground cardboard or the like treated with a fire retardant material such as borax and is placed on the floor of the attic. Traditional mass insulation such as fiberglass batt and loose fill can only absorb so much heat and when the maximum level is attained the heat will transfer to the living area through conductivity.

Insulation is generally referred to in terms of R-values, with the higher the R-value the greater the resistance to the transfer of heat.

The apparatus of the present invention provides the use of both foam insulation and reflective metalized film or radiant barrier to reduce heat conductivity and long wave radiation (radiant energy) into or out of enclosed building structures.

The apparatus of the present invention achieves a substantially increased efficiency in reflecting the long wave radiation and reducing the transfer of heat via conductivity due to the integration of foam insulation and reflective metalized film or radiant barrier into a single system. Extruded or expanded polystyrene foams have an established R value of approximately one (R1) for each ¼ inch of thickness. Combing the extruded or expanded polystyrene foam with a reflective metalized film or radiant barrier ensures the apparatus has both an R value and a reflective or E value (Emissivity)

Highly reflective aluminum foil or reflective metalized films are effective reflectors of radiant heat and are usually installed on the back of the attic ceiling or roof rafters they can also be laid on top of mass insulations installed over the floor joists; or draped under the roof deck. In some installations a dual energy saving function may be obtained where radiant heat transfer from the attic into the living area is reduced in the summer months and convection heat losses are reduced in the winter months by inhibiting the movement of air from the living area to the attic.

Reflectors of radiant heat are most effective in blocking summer heat gain and saving on air-conditioning costs. An insulating radiant barrier, when placed on top of an underlying attic floor insulation to form a laminate, can be used to control the temperature of the underlying living area in the summer and winter therefore reducing the need for air conditioning and heating thus saving energy and an expense.

### SUMMARY OF THE INVENTION

There is disclosed an insulating panel for inhibiting the passage of radiant and conductive heat from an attic to a room below or from a room below to an attic where the panel is laminated. The core of the panel is of extruded polystyrene or expanded polystyrene having a thickness of between 1/16 and 1½ of an inch. The core of the panel is coated with a fire retarding material which can be an adhesive and which is used to attach a reflective metalized film such as aluminum to each side of the core. Apertures are located in the core and reflective metalized films or radiant barrier to allow moisture to pass through the panel, and the panel is scored at different widths to allow it to be folded.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings.

FIG. 1A shows a cross-sectional view of a laminate according to the present invention having a base layer and a reflective metalized film or radiant barrier layer on each side of the base layer;

FIG. 2 shows an exploded view of a sheet of the laminate of FIG. 1; and

FIG. 3 is a partial sectional view where a laminate having a reflective metalized film or radiant barrier layer on each side surface is located on top of a ceiling joist.

### DETAILED DESCRIPTION OF THE INVENTION

During hot summer days as the sun heats a roof, most of the heat will pass through the roof shingles to the inside of the attic. This heat will then be transferred from the underside of the roof by radiation down through the attic to either the top of the layer of insulation on the attic floor or directly to the attic floor. Conversely, on cold winter day's heat from rooms located under the attic will rise into the attic.

A insulating reflective metalized film or radiant barrier that is located on the attic floor or the back of the roof rafters will significantly reduce the amount of radiant heat that can pass from the attic to the rooms in the home during the summer or if placed on the attic floor, then from the rooms in a home into the attic during the winter.

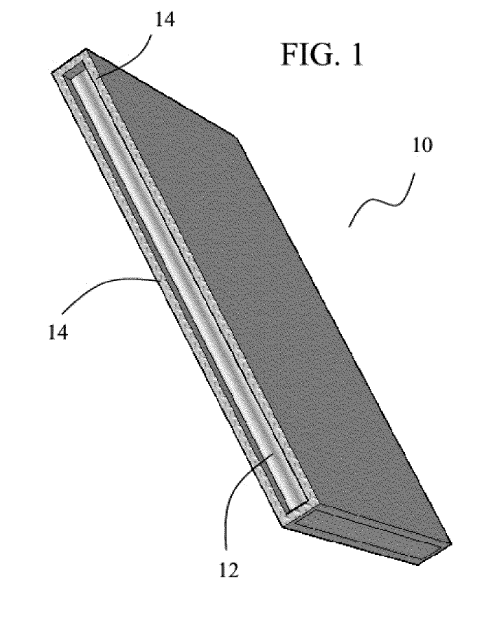

Referring to FIG. 1, there is shown a cross-sectional view of a radiant heat barrier 10 according to the present invention. The radiant heat barrier is a laminate of a base material of extruded polystyrene (XPS) or expanded polystyrene (EPS) 12 covered on each side with a thin reflective metalized film or radiant barrier 14. The base material of extruded polystyrene or expanded polystyrene is a combustible material. Therefore, the base material is first coated on each side surface and on each of its ends with a fire resistant adhesive, and using the fire resistant adhesive, thin reflective metalized films or radiant barrier are then attached to each of the sides of the base material of extruded polystyrene or expanded polystyrene.

Covering the base material with the fire resistant adhesive and the reflective metalized films or radiant barrier transforms the laminate into a class 1 fire rated material.

After the laminate is formed it is perforated with a plurality of apertures to prevent it from becoming a moisture barrier and it is scored along its length and/or width. The plurality of apertures is formed in the reflective metalized films or radiant barrier and the base material. These apertures extend completely through the laminate, the two reflective metalized films or radiant barrier, the base material, and the adhesive material thereby forming an open moisture vapor flow channels which create a level of moisture vapor permeability through the panel. In this way, moist air can pass through the panel. The apertures can have a cross sectional configuration that is circular, rectangular, square or irregular.

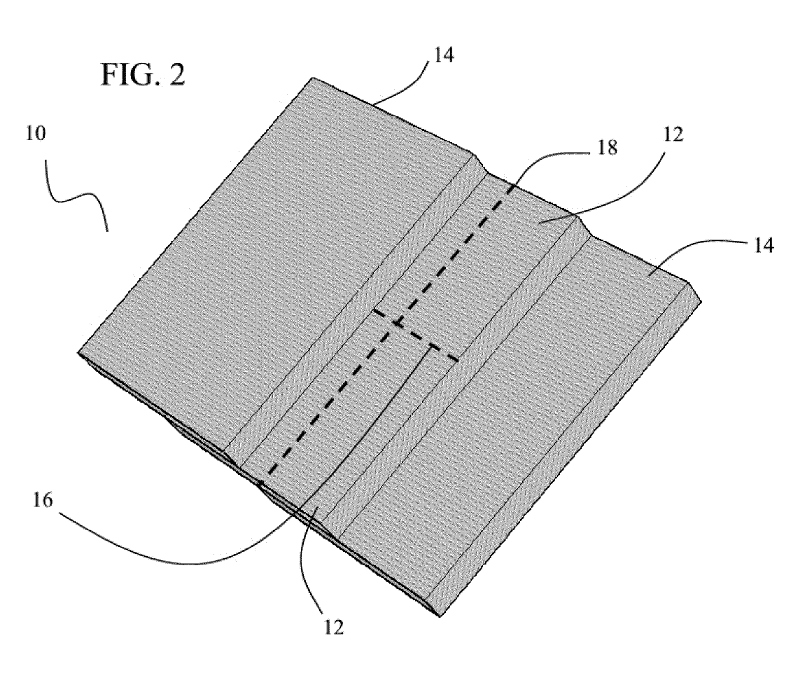

Referring to FIG. 2, there is shown an exploded view of a panel of the laminate of FIG. 1 where the laminate panel 10 having their reflective metalized film or radiant barrier 14 on each side of a extruded or expanded polystyrene core 12 is scored 16 along its length and its width 18 to allow it to be folded in its long dimension or its short dimension and is perforated with small through openings 18. When a sheet of laminate is folded along a fold line, the resulting fan fold panels provide a double sided insulating radiant barrier that is relatively rigid and can be folded for easy installation and removal. Thus, with the ability to fold a rigid panel, a user can make a quick and easy installation of the insulating radiant barrier into an area where heat is to be deflected.

Coating each side and the edges of an extruded polystyrene or expanded polystyrene sheet with a flame retardant adhesive and then using the flame retardant adhesive to attach a reflective metalized film or radiant barrier to each side of the sheet form a barrier which can placed on the floor of an attic or the underside of the roof rafters to isolate the temperature of the rooms below the attic from the heat in the attic or if placed on the attic floor to keep heat from rooms in the home escaping into the attic.

The laminate panels can be scored at any length but typically every 24 inches. The bundles can be manufactured in varying lengths. The core layer can have a thickness that varies from 1/16 of an inch up to 1½ of inches. The laminate panels can have a width of 4 feet, and they can be scored in varying lengths. The panels can be made with varying lengths.

The reflective metalized film or radiant barrier on each side of the panel can be a layer of standard consumer-grade aluminum foil, Mylar or any other highly reflective metalized material that reflects at least 90% of radiant heat.

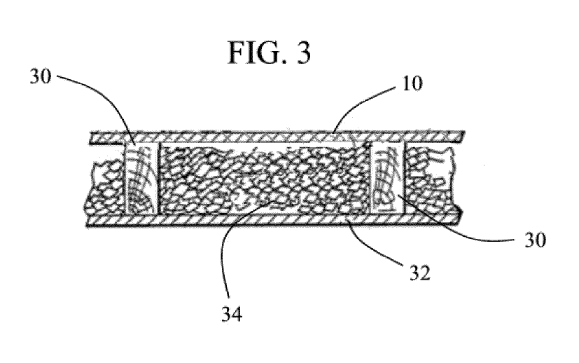

Referring to FIG. 3, there is shown a typical attic floor of exposed ceiling joists 30 with sheets of wall board 32 nailed or screwed to the bottom of the joists. The wall boards are the ceiling of the room below. The space between the joists may be filed with batts of insulation 34 or it may be empty. Today, in almost all homes this space is filled with insulation which was supplied by a builder. To provide additional insulation to the floor of the attic, the panels 10 here disclosed are laid down flat on top of the joists. The edges of the panels can overlap or placed butted together edge to edge. No special fitting is required.

It is not necessary to attach the panels to the top of the joists with nails or screws. They can be simply placed on top of the joists and on top of electrical wiring or water pipes that are on top of the joists. No special fitting or cutting of the panels is required. After the panels are placed over the joists in the attic, any portion of the attic floor can be reached for repairs or maintenance by simply removing one or more panels by fan-folding back together then replaced in seconds by expanding back into place. The invention is also rigid and flexible at the same time which allows the panels to easily be placed in hard to reach areas of the attic and for many other uses such as being attached to knee walls and head walls in attics, to cover garage doors, to enclose can lighting in the attic, to cover attic access doors. It can also be used to cover Home and Recreational Vehicles windows and skylights and placed under pier and beam foundation homes to reduce heat loss or gain.

While there have been shown and described and pointed out the fundamental novel features of the invention as applied to the preferred embodiments, it will be understood that various omissions and substitutions and changes of the form and details of the apparatus illustrated and in the operation may be done by those skilled in the art, without departing from the spirit of the invention.

What is claimed is:

1. An insulating fan-fold panel for inhibiting the passage of radiant and conductive heat there through comprising:
A sheet of extruded or expanded polystyrene which is flammable;
A coating of fire retarding material located on said sheet of extruded or expanded polystyrene; and
At least one reflective metalize film or radiant barrier located on the fire retarding material;
Wherein said panel is for use in an attic, under pier and beam foundations, windows, doors, and skylights to inhibit radiant and conductive heat from entering or leaving an enclosed structure.

2. The panel of claim 1 wherein said panel has apertures which allow moisture to pass through the panel.

3. The panel of claim 2 wherein the coating of fire retarding material covers at least one side of the panel.

4. The panel of claim 2 wherein the coating of fire retarding material covers each side of the panel.

5. The panel of claim 4 wherein said at least one metalized film is attached to a side of the panel.

6. The panel of claim 5 wherein said panel is extruded polystyrene.

7. The panel of claim 5 wherein said panel is expanded polystyrene.

8. The panel of claim 5 wherein said panel is extruded polystyrene or expanded polystyrene.

9. The panel of claim 8 wherein a reflective metalized film or radiant barrier is attached to each side of the panel.

10. The panel of claim 9 wherein said fire retarding material is used to attach the reflective metalized films or radiant barrier to the sides of the panel.

11. The panel of claim 10 wherein said reflective metalized films or radiant barrier are of aluminum.

12. The panel of claim 10 wherein said reflective metalized films or radiant barrier are of Mylar or some other reflective alloy.

13. The panel of claim 10 wherein said fire retarding material is an adhesive.

14. The panel of claim 10 wherein said fire retarding material covers the edges of the panel.

15. The panel of claim 10 wherein said panels are scored along a dimension to provide a panel that can be folded.

16. The panel of claim 10 wherein said apertures are irregular in shape.

17. The panel of claim 10 wherein said extruded polystyrene or expanded polystyrene has a thickness of between 1/16 inch and 1½ inches.

18. The panel of claim 17 wherein said panel is insulation and a radiant heat barrier.
